(19) United States
(12) Patent Application Publication
(10) Pub. No.: US 2021/0145012 A1
(43) Pub. Date: May 20, 2021

(54) DEVICES AND SYSTEMS FOR APPLYING SMOKE TO FOODS

(71) Applicant: David Hoodenpyl, Ellensburg, WA (US)

(72) Inventor: David Hoodenpyl, Ellensburg, WA (US)

(21) Appl. No.: 17/099,719

(22) Filed: Nov. 16, 2020

Related U.S. Application Data
(60) Provisional application No. 62/969,633, filed on Feb. 3, 2020.
(60) Provisional application No. 62/936,982, filed on Nov. 18, 2019.

(51) Int. Cl. A23B 4/052; A47J 37/07

(52) U.S. Cl. CPC A23B 4/052; A23V 2002/00; A47J 37/0786

(57) ABSTRACT

Devices and Systems for generating culinary cooking smoke are provided. As one example, a device is provided that includes an elongated housing defining a first plurality of holes and an internal cavity accessible by an opening at an end of the elongated housing. The device further includes (i) a magnetic-coupling mechanism, coupled to the elongated housing, configured to detachably couple the elongated housing to an underside of a cooking grill, and (ii) an end cap, detachably coupled to the end of the elongated housing, that is configured to close the opening of the elongated housing. Furthermore, the internal cavity is configured to house a smoke-generating material that produces smoke when heated, and the first plurality of holes is configured to direct the smoke produced by the smoke-generating material toward the cooking grill.

### CROSS REFERENCE TO RELATED APPLICATIONS

This application claims priority to U.S. Provisional Application Ser. No. 62/969,633, filed Feb. 3, 2020, entitled “Devices And Systems For Applying Smoke To Foods,” which is incorporated by reference herein in its entirety, and U.S. Provisional Application Ser. No. 62/936,982, filed Nov. 18, 2019, entitled “Devices And Systems For Applying Smoke To Foods,” which is incorporated by reference herein in its entirety.

### TECHNICAL FIELD

The present disclosure relates generally to cooking food, and more particularly to devices and systems for generating and applying culinary smoke to foods.

### BACKGROUND

Most grilling today, such as outdoor barbequing, typically involves cooking foods using one of three main heat sources: charcoal, propane, or natural gas. While these heat sources are fully capable of cooking various foods, they themselves impart little, if any, unique flavors into the cooked food. Because of this, cooks add wood (e.g., wood chips) with a primary heat source to impart additional flavors into their grilled foods through the creation of smoke (e.g., apple smoke, hickory smoke, etc.). The process of adding wood to the primary heat source traditionally has involved placing small pieces of wood directly on the primary heat source, or placing wood chips in a foil pan on the surface of the grill or next to the coals.

The traditional processes outlined above suffer from several drawbacks, including that the wood typically must be soaked in water for a period of time before being paired with the primary heat source to ensure that the wood does not burn too rapidly. Furthermore, smoke generated by the wood is not directed in any particular direction, and, consequently, the traditional processes are ineffective on open grills or when the cooking time is relatively short, such as when grilling burgers, steaks, etc. In addition, pairing wood with gas-based grills (propane and natural gas) can be problematic because (i) burners on a gas-based grill are typically arranged in a way that makes placing wood in contact with the burners difficult and (ii) removing ash resulting from the wood can be challenging.

### SUMMARY

Accordingly, there is a need for a device that, when paired with a primary heat source, can deliver smoke flavor to grilled foods without suffering from the drawbacks discussed above. Embodiments discussed herein are directed toward a portable device that can be magnetically attached to the underside of a grilling surface. In some embodiments, the portable device can be placed directly under a food article that is being cooked. The portable device is also designed to (i) house a smoke-generating material, such as wood chips, wood pellets, or spices, and (ii) direct smoke generated by the smoke-generating material in a desired direction. In other words, if the portable device is placed directly under a food article being cooked, then the smoke generated by the smoke-generating material inside the device can, essentially, be directly applied to the food article being cooked. Furthermore, because positioning of the portable device is versatile, due to magnetism being used as the attachment means (at least in some embodiments), a person using the portable device can position the portable device in numerous locations and orientations on the cooking grill. When the portable device is placed directly under a food item (or vice versa), it blocks some of the heat from the heat source and absorbs some heat to generate the smoke. By blocking heat coming from the heat source and allowing the smoke generated by the portable device to take its place, additional flavors are able to penetrate the food items before the heat from the heat source has seared the item (which can hamper the food item's ability to absorb additional smoke flavor).

Moreover, in some embodiments discussed herein, the device can be spliced together with one or more other devices, which allows for the application of smoke to a greater surface area. In such embodiments, each of the devices may house a different smoke-generating material (e.g., one may include apple wood, one may include almond wood, one may be a mix of wood chips, etc.), which allows for the creation of unique flavor profiles.

(A1) In some embodiments, an apparatus/device is provided that includes an elongated housing defining a first plurality of holes and an internal cavity accessible by an opening at an end of the elongated housing. The apparatus further includes (i) a magnetic-coupling mechanism (e.g., magnets 106-A and 106-B in FIG. 1A, or the magnet pairs 106-A, 107-A, 106-B, and 107-B in FIG. 1C), coupled to the elongated housing, configured to detachably couple the elongated housing to an underside of a cooking grill, and (ii) an end cap, detachably coupled to the end of the elongated housing, that is configured to close the opening of the elongated housing. Furthermore, the internal cavity is configured to house a smoke-generating material that produces smoke when heated, and the first plurality of holes is configured to direct the smoke produced by the smoke-generating material toward the cooking grill. In some embodiments, the elongated housing further defines a second plurality of holes on a substantially opposite portion of the elongated housing from the first plurality of holes. The second plurality of holes is configured to distribute heat inside the internal cavity to ignite the smoke-generating material housed therein.

(B1) In some embodiments, a system is provided that includes the apparatus of A1. The system further includes a fuel pod with: (i) smoke-generating material configured to produce smoke when heated and (ii) a sleeve that surrounds the smoke-generating material, whereby a shape of the pod complements a shape of the internal cavity of the elongated housing. Furthermore, the internal cavity is configured to receive and house the pod, and the first plurality of holes is configured to direct smoke produced by the smoke-generating material toward the cooking grill.

(C1) In some embodiments, an apparatus is provided that includes a cylindrical shell with an internal cavity accessible by an opening at an end of the cylindrical shell, whereby the cylindrical shell also defines a plurality of smoke-emitting ports. The apparatus also includes two or more magnets, coupled to the cylindrical shell, configured to detachably couple the cylindrical shell to an underside of a cooking grill, and an end cap, detachably coupled to the end of the cylindrical shell, that is configured to close the opening of the cylindrical shell. Furthermore, the internal cavity is configured to house a smoke-generating material that produces smoke when heated. Also, the plurality of smoke-emitting ports is configured to direct the smoke produced by the smoke-generating material toward the cooking grill.

(D1) In some embodiments, an apparatus is provided that includes (i) housing means for housing a smoke-generating material (e.g., elongated housing 102, FIG. 1A), (ii) magnetic means for detachably coupling the housing means to an underside of a cooking grill (e.g., magnets 106-A and 106-B, FIG. 1A), (iii) means for uniformly distributing heat onto the smoke-generating material (e.g., holes 116, FIG. 3B), and (iv) means for directing smoke produced by the smoke-generating material toward the cooking grill (e.g., holes 108, FIG. 1A).

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1A is an oblique view of an example smoke-generating device for generating cooking smoke in accordance with some embodiments.

FIG. 1B is another oblique view of an example smoke-generating device for generating cooking smoke in accordance with some embodiments.

FIG. 1C is another oblique view of an example smoke-generating device for generating cooking smoke in accordance with some embodiments.

FIG. 1D is an oblique view of an example smoke-generating device for generating cooking smoke in accordance with some embodiments.

FIG. 1E is another oblique view of an example smoke-generating device for generating cooking smoke in accordance with some embodiments.

FIG. 1F is another oblique view of an example smoke-generating device for generating cooking smoke in accordance with some embodiments.

FIG. 2A shows the example smoke-generating device of FIGS. 1A and 1B coupled to a grilling surface of an outdoor grill in accordance with some embodiments.

FIG. 2B shows a side view of the example smoke-generating device of FIGS. 1A and 1B coupled to a grilling surface of an outdoor grill in accordance with some embodiments.

FIGS. 3A and 3B show top and bottom views of the example smoke-generating device of FIGS. 1A and 1B in accordance with some embodiments.

FIG. 3C shows a cross-sectional view (taken along line A-A¹ of FIG. 2B) of the example smoke-generating device of FIGS. 1A and 1B in accordance with some embodiments.

FIGS. 4A and 4B show additional components for the example smoke-generating device of FIGS. 1A and 1B in accordance with some embodiments.

FIG. 4C shows how two smoke-generating devices can be spliced together in accordance with some embodiments.

FIG. 5 shows a fuel pod that is sized to fit into the example smoke-generating device of FIGS. 1A and 1B in accordance with some embodiments.

FIG. 6 shows a computer rendering of an example smoke-generating device.

FIG. 7 shows an alternative use for the device in FIGS. 1A and 1B.

FIG. 8 is an oblique view of another example smoke-generating device for generating cooking smoke in accordance with some embodiments.

FIG. 9 shows a grease shield that is sized to fit into the example smoke-generating device of FIGS. 1A and 1B in accordance with some embodiments.

FIGS. 10A and 10B show additional grease shields that fit with the example smoke-generating device of FIGS. 1A and 1B in accordance with some embodiments.

FIGS. 11A and 11B show alterative configuration for the elongated housing, the smoke-emitting ports, and the heat-intake ports.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

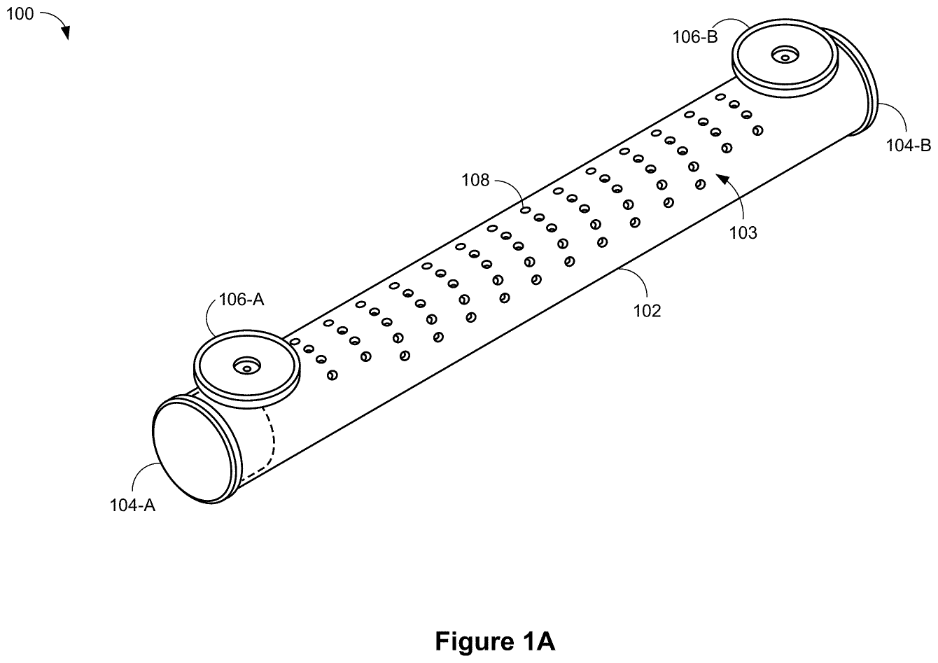

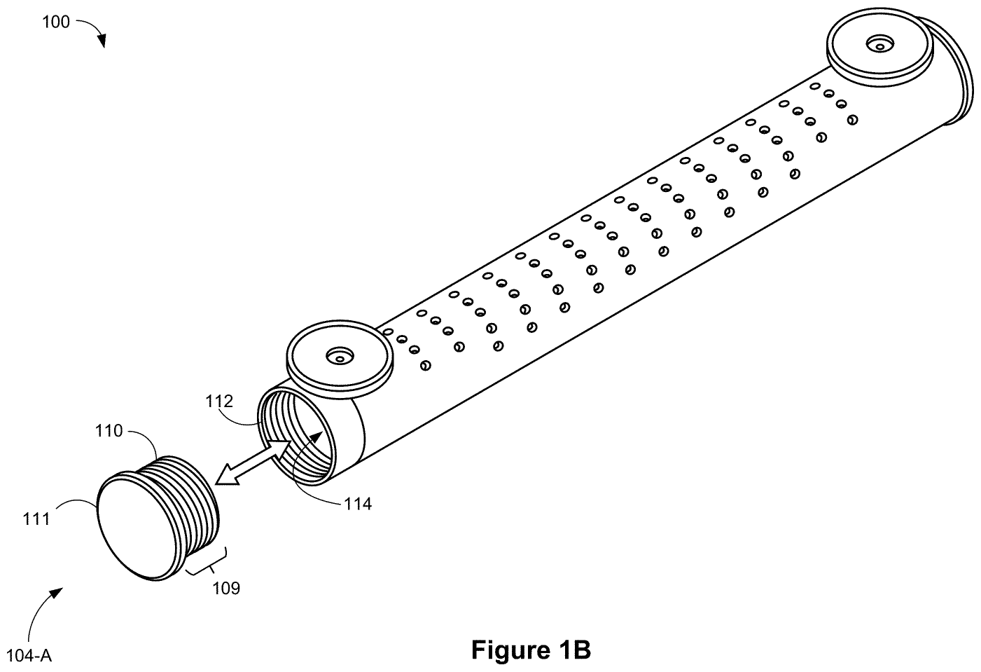

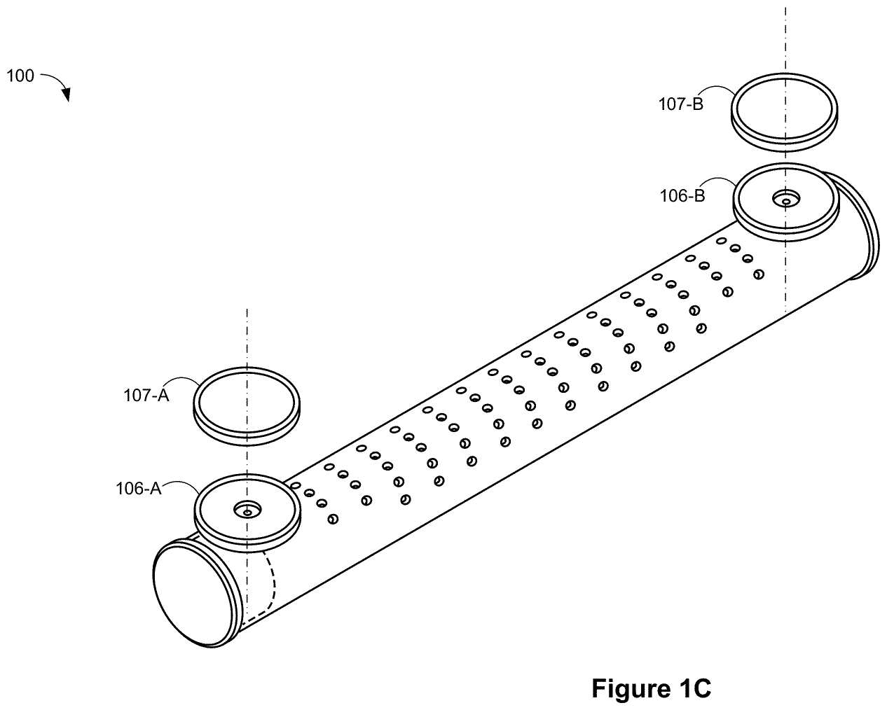

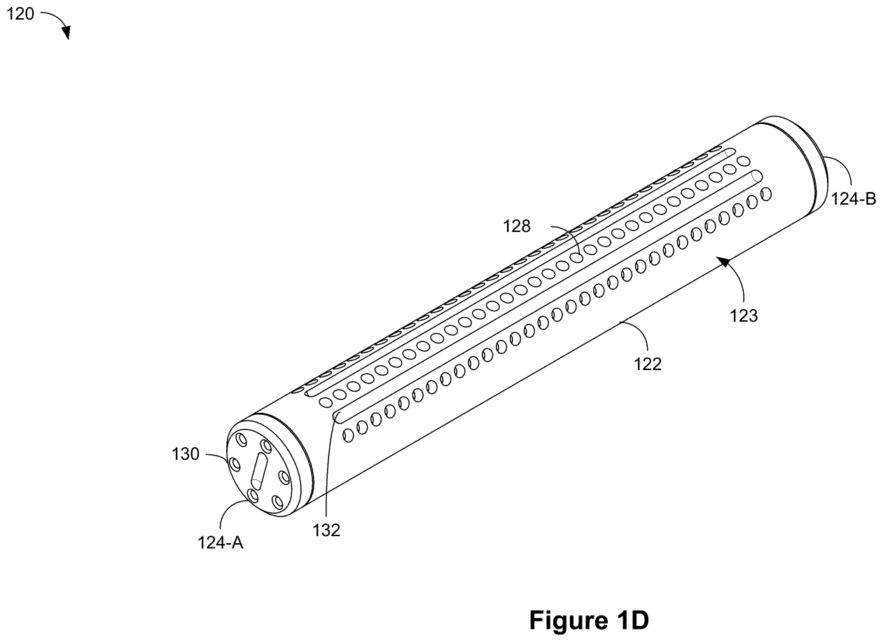

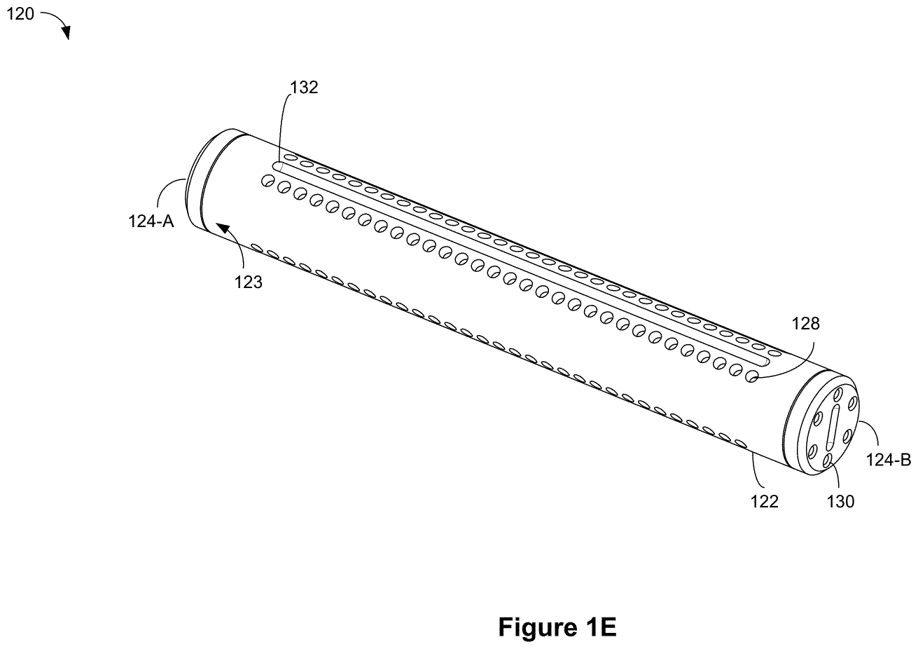

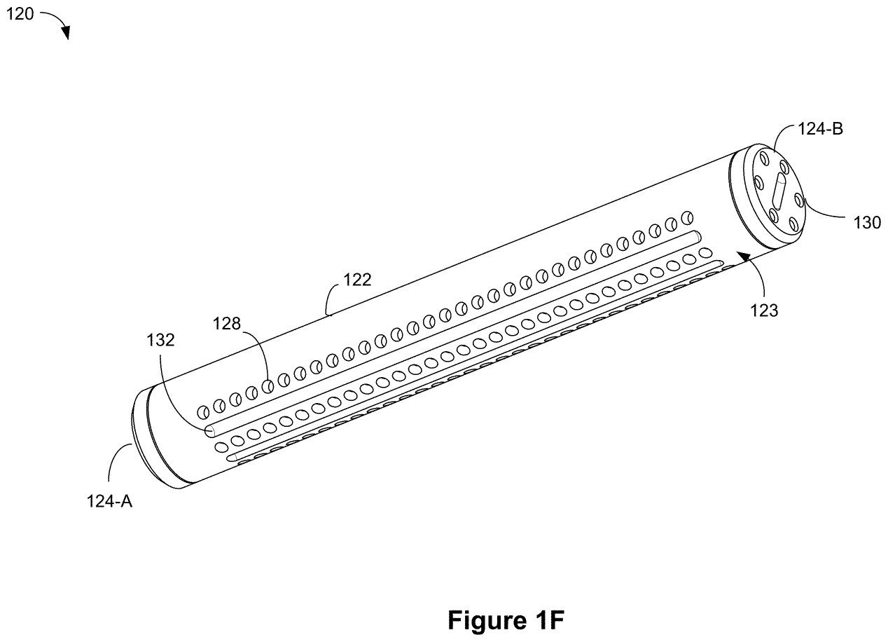

FIG. 1A is an oblique view of an example smoke-generating (or emitting) device 100 (which is sometimes referred to herein as a “smoke-generating apparatus,” a “smoke-emitting apparatus,” or simply as an “apparatus” or a “device”) for generating cooking smoke in accordance with some embodiments. As shown, the smoke-generating device 100 includes an elongated housing 102, a first end cap 104-A, a second end cap 104-B, a first magnet 106-A, a second magnet 106-B, and a plurality of holes 108 defined in a first portion 103 (or a first surface 103) of the elongated housing 102. In some instances herein, the first portion 103 of the elongated housing 102 is referred to as a “top portion 103” or a “top surface 103” of the elongated housing 102. Note that references herein to “top” and “bottom” are used for ease of discussion, and not used to delineate a preferred orientation of the smoke-generating device 100. Furthermore, in some embodiments, the smoke-generating device 100 does not include one or more of the components shown in FIG. 1A. For example, the smoke-generating device 100 may only include a single end cap 104 in some instances. With the above in mind, the illustrated components of the smoke-generating device 100 are discussed below.

The elongated housing 102 is made from a heat-resistant material, such as stainless steel, cast iron, ceramics, etc. In the illustrated embodiment, the elongated housing 102 is a cylindrical shell with an internal cavity 114 (FIG. 1B) accessible by an opening (or openings) defined by an end (or both ends) of the elongated housing 102. However, in some other embodiments, the elongated housing 102 may be other hollowed-out shapes, such as a rectangular shell, a triangular shell, a hexagonal shell, etc. To provide some context, the elongated housing 102 may be approximately 6-12 inches long and 1-2 inches wide, at least in some embodiments. The elongated housing 102 is configured to (designed to, constructed to) house a smoke-generating material, such as wood chips, wood pellets, aromatic herbs, aromatic spices, a liquid, and a combination of the aforementioned. While not shown in FIG. 1A, in some embodiments, the elongated housing 102 defines openings at its respective ends (e.g., a first opening defined at the left end of the elongated housing 102 and a second opening defined at the right of the housing 102).

The first end cap 104-A and the second end cap 104-B are detachably coupled to respective ends of the elongated housing 102 and are configured to close respective openings of the elongated housing 102. Like the elongated housing 102, the end caps 104 may be made from a heat-resistant material, such as stainless steel, cast iron, etc. In some embodiments, the end caps 104 are made from the same material as the elongated housing 102, while in some other embodiments, the ends caps 104 are made from a different material than the elongated housing 102. As noted above, in some embodiments, the smoke-generating device 100 includes a single end 104. In such embodiments, the elongated housing 102 defines a single opening (e.g., at the left end or a right end of the housing 102), and the single opening is closed by a single end cap (e.g., the first end cap 104-A or the second end cap 104-B).

With reference to FIG. 1B, the first end cap 104-A includes a protruding portion 109 that defines a set of threads 110 and an annular portion 111. Furthermore, still with reference to FIG. 1B, the elongated housing 102 may define a corresponding set of threads 112 that complement the set of threads 110 of the first end cap 104-A. Accordingly, the first end cap 104-A may be fastened to the elongated housing 102 using the sets of threads 110 and 112 shown in FIG. 1B. While not shown, the smoke-generating device 100 may include a similar arrangement of threads at the opposite end of the elongated housing 102. Furthermore, in some embodiments, a different mechanism is used by the end cap 104 to close a respective opening of the elongated housing 102. For example, a respective end cap 104 may be detachably coupled to a respective end of the elongated housing 102 using magnets, a spring-locking mechanism, an external latching device, or some other mechanism. Also, the threading shown in FIG. 1B may be reversed, such that the elongated housing 102 is the male component and the end cap 104 is the female component.

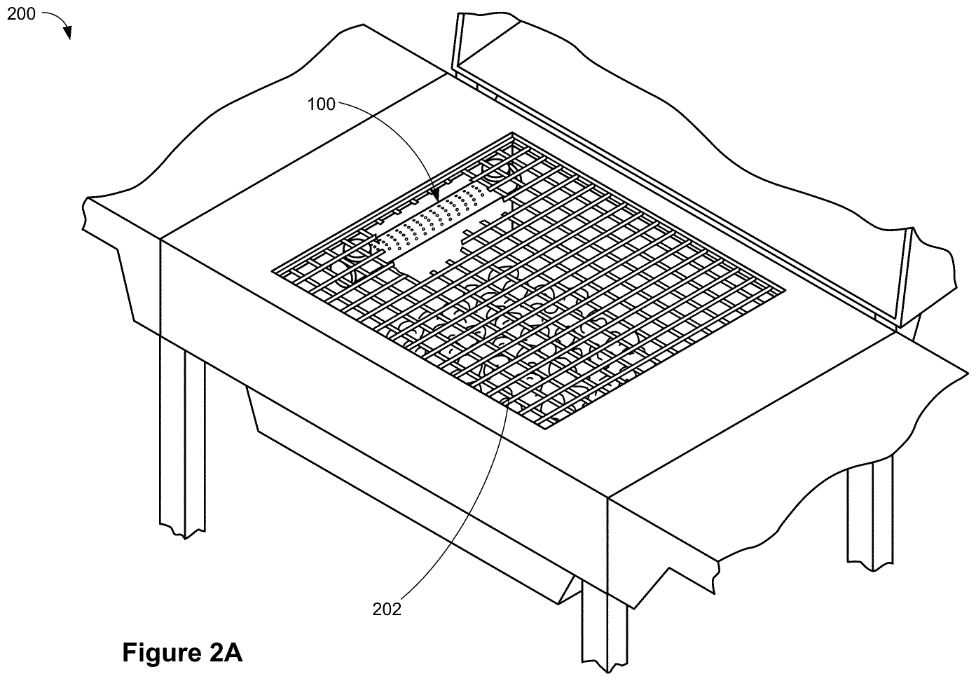

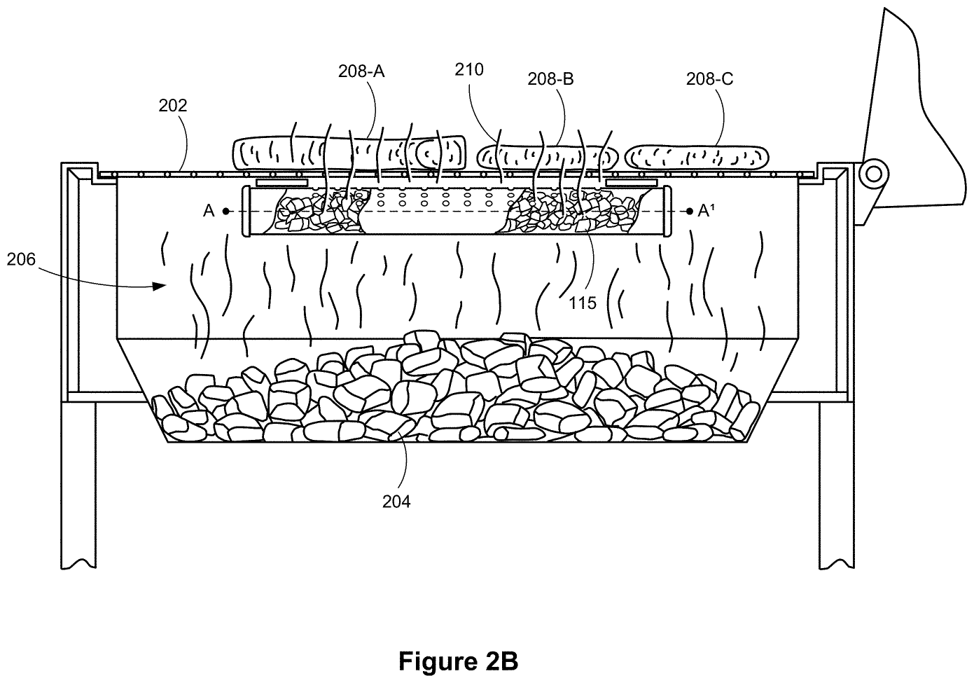

Back to FIG. 1A, the first magnet 106-A and the second magnet 106-B are coupled to the first portion 103 of the elongated housing 102 (note that, in some embodiments, the device 100 includes more than two magnets 106 coupled to the first portion 103 of the elongated housing 102). As will be described in more detail below with reference to FIGS. 2A and 2B, the first magnet 106-A and the second magnet 106-B are configured to detachably couple the elongated housing 102 to an underside of a cooking surface (e.g., grill 202 in FIG. 2A) or some other surface, which may or may not be magnetized. The first magnet 106-A and the second magnet 106-B may be a variety of magnets, including various rare-earth magnets and the like. In one example, the first and second magnets 106-A, 106-B can be made of an aluminum, nickel, and cobalt (Alnico) ferromagnetic material, which is a material that has been found by the inventor to be particularly beneficial for withstanding the heat to which the magnets are exposed when the device 100 is coupled to an operating grilling device. The first magnet 106-A and the second magnet 106-B may be mechanically fastened to the elongated housing 102 (e.g., using mechanical fasteners, such as screws, bolts, and/or threading) and/or chemically fastened to the elongated housing 102 (e.g., using an adhesive).

Notably, the first magnet 106-A and the second magnet 106-B have low profiles (e.g., the magnets 106 are coin/disk shaped), which decreases a separation distance between a top surface (i.e., a coupling surface) of the magnets 106 and the top surface 103 of the elongated housing 102. In this way, the top surface 103 of the elongated housing 102 can in turn be positioned close to a cooking surface, which allows for smoke generated by the smoke-generating device 100 to immediately interact with a target food (discussed in more detail below with reference to FIGS. 2A and 2B). Moreover, the first magnet 106-A and the second magnet 106-B each have a flat surface for engaging with the cooking surface (e.g., the magnets 106 may be magnetically engaged with multiple bars of the grill 202). In some other embodiments, the first magnet 106-A and the second magnet 106-B substantially surround the elongate housing 102 near each end (i.e., the magnets 106 are ring magnets or close to ring magnets).

It is also noted that the first magnet 106-A and the second magnet 106-B are coupled to the elongated housing 102 in the preferred embodiment, as opposed to the first end cap 104-A and the second end cap 104-B. In doing so, a size of the end caps 104 can be decreased (e.g., annular portion 111 can be slender, as shown in FIGS. 1A-1C), which decreases an overall manufacturing cost of the device 100, as well as a mass of the device 100.

With reference to FIG. 1C, the smoke-generating device 100 may include additional magnets 107-A and 107-B that can be used to couple the smoke-generating device 100 to nonmagnetic surfaces, such as nonmagnetic grilling surfaces. In this arrangement, the first magnet 106-A and the second magnet 106-B are to be positioned below the grilling surface (e.g., in the arrangement shown in FIGS. 2A and 2B), while the additional magnets 107-A and 107-B are to be positioned above the grilling surface and coaxially aligned with the first magnet 106-A and the second magnet 106-B. In doing so, the additional magnets 107-A and 107-B magnetically interact with the first magnet 106-A and the second magnet 106-B to secure the smoke-generating device 100 to the grilling surface.

Back to FIG. 1A, the plurality of holes 108 are defined in the top surface 103 of the elongated housing 102, as mentioned above. In some instances, the plurality of holes 108 are referred to herein as “smoke-emitting ports 108” or “substance-emitting ports 108.” As shown, the plurality of holes 108 extend along a longitudinal length of the elongated housing 102 in multiple rows. The plurality of holes 108 can be defined in various patterns, and the arrangement of the holes 108 in FIG. 1A in merely one possible arrangement (e.g., there could be a single row of holes 108, a zigzag pattern of holes 108, etc.). Notably, the plurality of holes 108 are configured to direct smoke (or some other diffusible substance) away from the top surface 103 of the elongated housing 102 toward the cooking surface, as shown in FIG. 2B. In some embodiments, the plurality of holes 108 are limited to an upper half (i.e., a top half) of the elongated housing 102, which ensures that the smoke (or other substance) is directed solely in a preferred direction. It should also be noted that the plurality of holes 108 may be in a shape, other than holes. In other words, various apertures can be used in place of the plurality of holes 108, such as a variety of slot shapes. In some instances, the plurality of holes 108 are said to form an array of holes.

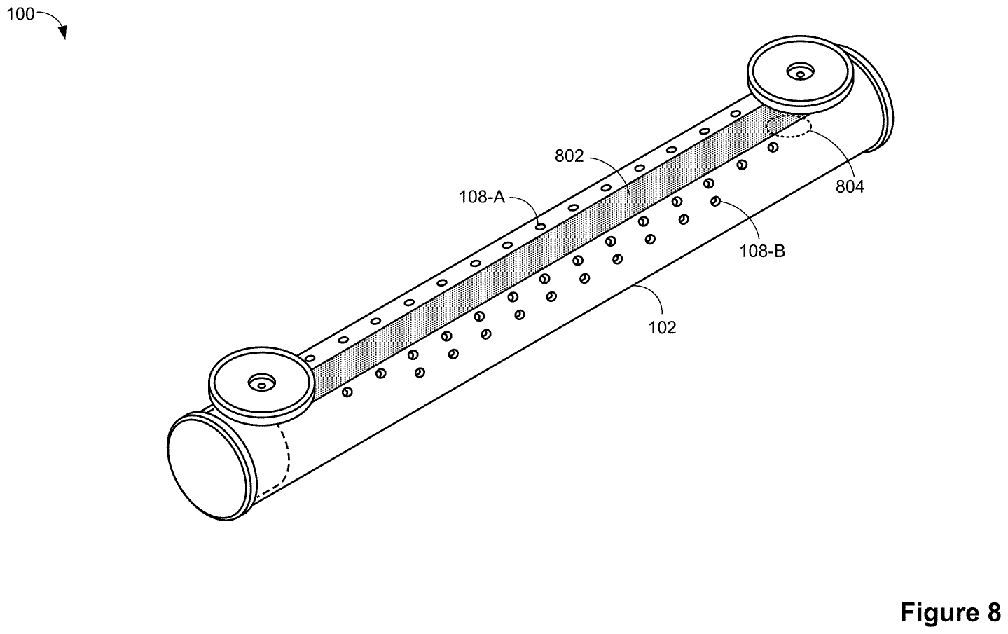

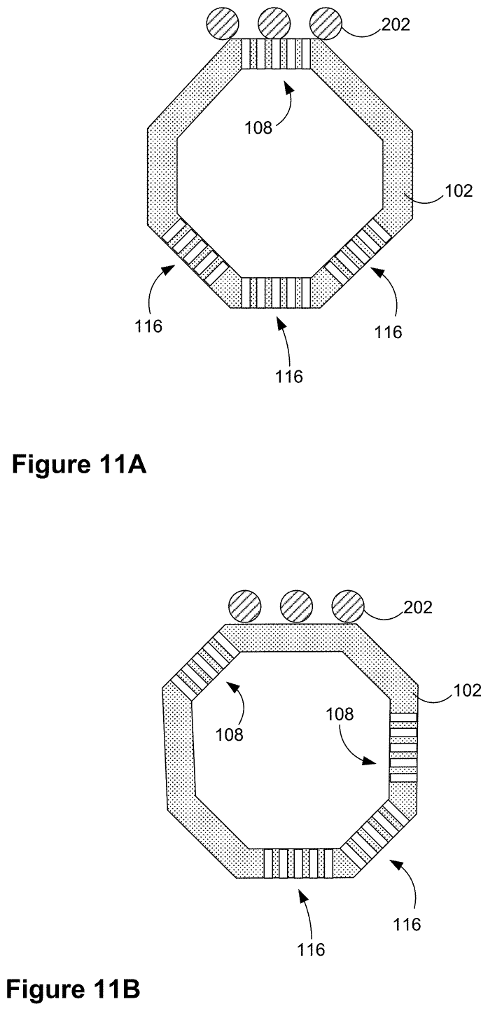

In some embodiments, a diameter of each hole in the plurality of holes 108 is less than a threshold diameter, whereby the threshold diameter is a diameter at which grease and oil tend to not clog (or otherwise enter) the plurality of holes 108, but rather slide away from the plurality of holes 108 along the elongated housing 102. In some embodiments, the threshold diameter is equal to or less than ⅛ inch. In some embodiments, the threshold diameter is equal to or less than 1/16 inch. As such, the smoke-generating device 100 may include at least one mechanism to prevent against the smoke-emitting ports 108 from clogging. Additional mechanisms that can be used to prevent grease and oil from clogging the plurality of holes 108, or from interacting with the smoke-generating material housed by the housing 102, are discussed below with reference to FIGS. 8-10B. Also, additional layouts/patterns of the smoke-emitting ports 108 are discussed below with reference to FIG. 8 and FIGS. 11A and 11B.

In some embodiments, one or more shallow valleys 132 (depicted and described below with reference to FIGS. 1D-1F) can be added to the smoke-generating device 100, to thereby produce a smoke-generating device 120. Although a new reference numeral is used for clarity and ease of understanding, one of skill will understand that the descriptions regarding smoke-generating device 100 throughout this disclosure also apply to the smoke-generating device 120. In some embodiments, and as explained more below, the one or more shallow valleys 132 are interspersed between rows of intake holes 128.

FIG. 1D is an oblique view of another example smoke-generating (or emitting) device 120 (which is sometimes referred to herein as a “smoke-generating apparatus,” a “smoke-emitting apparatus,” or simply as an “apparatus” or a “device”) for generating cooking smoke in accordance with some embodiments. As shown, similar to the smoke-generating device 100 (described above in reference to FIGS. 1A-1C), the smoke-generating device 120 includes an elongated housing 122, a first end cap 124-A, a second end cap 124-B, and a plurality of holes 128 defined in a first surface 123 of the elongated housing 122. Furthermore, in some embodiments, the smoke-generating device 120 does not include one or more of the components shown in FIG. 1D. For example, the smoke-generating device 120 may only include a single end cap 124 in some instances. With the above in mind, the illustrated components of the smoke-generating device 120 are discussed below.

Similar to the elongated housing 102, the elongated housing 122 can be made from a heat-resistant material, such as stainless steel, cast iron, ceramics, etc. In the illustrated embodiment, the elongated housing 122 is a cylindrical shell with an internal cavity (not shown; similar to the internal cavity 114 described above in reference to FIG. 1B) accessible by an opening (or openings) defined by an end (or both ends) of the elongated housing 122. However, in some other embodiments, the elongated housing 122 may be other hollowed-out shapes, such as a rectangular shell, a triangular shell, a hexagonal shell, etc. To provide some context, the elongated housing 122 may be approximately 6-12 inches long and 1-2 inches wide, at least in some embodiments. The elongated housing 122 is configured to (designed to, constructed to) house a smoke-generating material, such as wood chips, wood pellets, aromatic herbs, aromatic spices, a liquid, and a combination of the aforementioned. While not shown in FIG. 1A, in some embodiments, the elongated housing 122 defines openings at its respective ends (e.g., a first opening defined at the left end of the elongated housing 122 and a second opening defined at the right of the housing 122).

The first end cap 124-A and the second end cap 124-B are detachably coupled to respective ends of the elongated housing 122 and are configured to close respective openings of the elongated housing 122. Like the elongated housing 122, the end caps 124 may be made from a heat-resistant material, such as stainless steel, cast iron, etc. In some embodiments, the end caps 124 are made from the same material as the elongated housing 122, while in some other embodiments, the ends caps 124 are made from a different material than the elongated housing 122. As noted above, in some embodiments, the smoke-generating device 120 includes a single end 124. In such embodiments, the elongated housing 122 defines a single opening (e.g., at the left end or a right end of the housing 122), and the single opening is closed by a single end cap (e.g., the first end cap 124-A or the second end cap 124-B).

The plurality of holes 128 (sometimes called intake holes) are defined in the surface 123 of the elongated housing 122, as mentioned above. In some instances, the plurality of holes 128 are referred to herein as “smoke-emitting ports 128” or “substance-emitting ports 128.” As shown, the plurality of holes 128 extend along a longitudinal length of the elongated housing 122. The plurality of holes 128 can be defined in various patterns, and the arrangement of the holes 128 in FIG. 1D is merely one possible arrangement (e.g., there could be a single line of holes 128, a zigzag pattern of holes 128, etc.). Notably, the plurality of holes 128 are configured to direct smoke (or some other diffusible substance) away from the surface 123 of the elongated housing 122 toward the cooking surface, as shown in FIG. 2B. In some embodiments, although not shown, the plurality of holes 128 are limited to an upper half (i.e., a top half) of the elongated housing 122, which ensures that the smoke (or other substance) is directed solely in a preferred direction. In some embodiments, as shown in FIG. 1E, the plurality of holes 128 are limited to two or more portions (e.g., a top portion and a bottom portion) of the elongated housing 122, so that the smoke (or other substance) is directed in two or more preferred directions. Some embodiments include rows of holes on both sides (as opposed to just on top) so as to allow for directing smoke (or flavor) to the grilled food more quickly, which ensures that more flavor from the smoke is imparted on to the grilling meat (or other grilled article) more quickly. Some embodiments include rows of holes on both sides of the surface so that air intake and associated heat cause pellets (e.g., dense pellets) to start. Some embodiments include an insertable type of large pellets or pods, so the rows of holes on both sides provides heat intake to start such pellets to smoke.

It should also be noted that the plurality of holes 128 may be in a shape, other than holes. In other words, various apertures can be used in place of the plurality of holes 128, such as a variety of slot shapes. In some instances, the plurality of holes 128 are said to form an array of holes.

In some embodiments, the plurality of holes 128 are arranged as columns (or rows) of holes that extend along a longitudinal length of the elongated housing 122, as shown in FIGS. 1D-1F. In some embodiments, the columns of holes are separated by valleys 132 (e.g., shallow valleys). In some embodiments, such valleys 132 create faster heat transfer in areas surrounding the valleys 132, as compared to other areas on the elongated housing 122 other than the valleys 132.

Some embodiments include a plurality of holes 130 on the end caps 124, which helps to ensure quicker starting/igniting of the dense pellets discussed above, and to also ensure that more smoke is released from the smoke-generating device 120 in more directions. Some embodiments include a plurality of holes on only one of the two end caps (e.g., the first end cap 124-A or the second end cap 124-B).

In some embodiments, a diameter of each hole in the plurality of holes 128 is less than a threshold diameter, whereby the threshold diameter is a diameter at which grease and oil tend to not clog (or otherwise enter) the plurality of holes 128, but rather slide away from the plurality of holes 128 along the elongated housing 122. In some embodiments, the threshold diameter is equal to or less than ⅛ inch. In some embodiments, the threshold diameter is equal to or less than 1/16 inch. As such, the smoke-generating device 120 may include at least one mechanism to prevent against the smoke-emitting ports 128 from clogging. Additional mechanisms that can be used to prevent grease and oil from clogging the plurality of holes 128, or from interacting with the smoke-generating material housed by the housing 122, are discussed below with reference to FIGS. 8-10B.

FIG. 1E is another oblique view showing the top portion of example smoke-generating device 120, rotated relative to FIG. 1D to more clearly depict the other end cap 124-B, for generating cooking smoke in accordance with some embodiments. FIG. 1E illustrates an example in which the holes 130 are included on end cap 124-B, which helps to ensure quicker starting/igniting of the dense pellets discussed above, and to also ensure that more smoke is released from the smoke-generating device 120 in more directions. FIG. 1E also shows that holes 128 can also be repeated on a bottom surface of the smoke-generating device 120, which allows for the release of more of the flavor-imparting smoke in more directions.

FIG. 1F is another oblique view of the example smoke-generating device 120, rotated to show a bottom portion of the smoke-generating device 120, for generating cooking smoke in accordance with some embodiments. As depicted in FIG. 1F, an arrangement of holes 128 and valleys 132 can be symmetrically repeated on both the top and bottom surfaces of the smoke-generating device 120. In some other embodiments, the arrangement of holes and valleys can be asymmetrical between the top and bottom portions of the smoke-generating device 120. For instance, instead of an arrangement of a row of holes 128 adjacent to a valley 132, followed by another row of holes 128, followed by another valley 132, and, finally, a last row of holes 128, the smoke-generating device 120's bottom portion can instead include three values 132 and two rows of holes 128, or four rows of holes 128 with one value 132 therebetween. Upon reading the descriptions herein, one of skill in the art will appreciate that various other arrangements are possible (e.g., five rows of holes with two valleys therebetween, or 3 valleys with 3 rows or holes interspersed therebetween, etc.), and within the scope of this disclosure.

As one of skill in the art will also appreciate, the depictions in FIGS. 1D-1F show that end caps 124 can be flush with respective ends of the elongated housing 122, instead of one or more of the end caps 124 rising at least slightly (e.g., ¼, ⅙, ⅛ inch or less) above one or more respective ends of the elongated housing 122. In some embodiments, one of the end caps (e.g., end cap 124-A) can be flush with a first end of the elongated housing 122, while another end cap (e.g., end cap 124-B) can rise at least slightly (e.g., ¼, ⅙, ⅛ inch or less) above a second end of the elongated housing 122. Further, while FIGS. 1D-1F are depicted without elements 106-A, 107-A, 106-B, and 107-B for the sake of simplicity and to avoid obscuring other illustrated components, one of skill in the art will appreciate that these elements can also be used in conjunction with the embodiments depicted in FIGS. 1D-1F (e.g., to allow for securely coupling the smoke-generating device 120 to a grilling device in the fashion depicted in FIGS. 2A and 2B).

It is noted that, although the following discussions refer to the smoke-generating device 100, the discussions also apply to the example smoke-generating device 120.

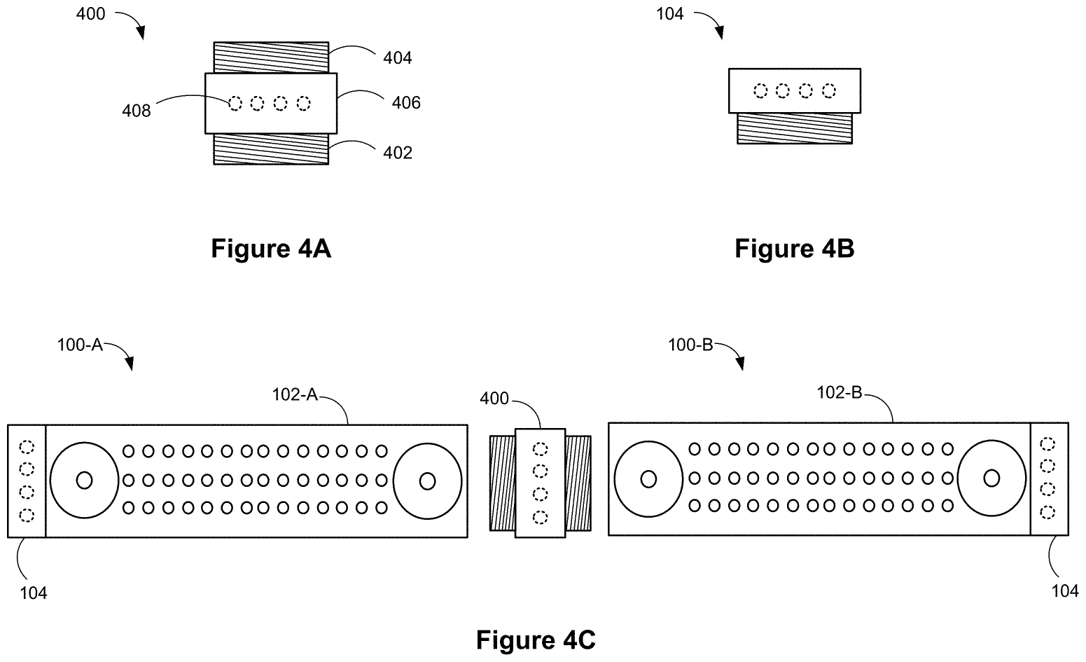

FIG. 2A shows the example smoke-generating device 100 of FIGS. 1A and 1B coupled to a grilling surface 202 of an outdoor grill 200 in accordance with some embodiments. In FIG. 2A, a portion of the grilling surface 202 has been cut away for illustrative purposes (i.e., to show the example smoke-generating device 100 and, in particular, positions of the plurality of holes 108 of the elongated housing 102 relative to the grilling surface 202). Notably, due to the slender design of the example smoke-generating device 100 as a whole, multiple instances of the smoke-generating device 100 can be attached to the underside of the grill 202 at the same time (either separately or spliced together, as described below with reference to FIGS. 4A and 4B).

FIG. 2B shows a side view of the example smoke-generating device 100 of FIGS. 1A and 1B coupled to a grilling surface 202 of an outdoor grill 200 in accordance with some embodiments. For ease of illustration and discussion, portions of the example smoke-generating device 100 are cut away in FIG. 2B to show a smoke-generating material 115 inside the internal cavity 114 of the elongated housing 102. As shown, a heat source 204 (charcoal in this case) of the outdoor grill 200 generates heat 206 that (i) cooks food 208-A, 208-B, and 208-C positioned on the grill 202 and (ii) heats/ignites the smoke-generating material 115 housed by the elongated housing 102. The smoke-generating material 115 is configured to generate smoke 210 when heated or otherwise ignited (e.g., apple smoke, hickory smoke, etc.). Notably, the smoke 210 generated by the smoke-generating material 115 exits the holes 108 of the elongated housing 102 and almost immediately interacts with the food 208 on the grill 202 (due, in part, to the low-profile design of the magnets 106). In doing so, the smoke-generating device 100 efficiently imparts additional smoke-based flavors onto the food 208. Moreover, because the holes 108 are distributed across the top surface 103 of the elongated housing 102, the smoke 210 is equally distributed across a surface area of the food 208, thereby imparting a uniform smoke flavor across the food surface. It is worth noting that the slender design of the smoke-generating device 100 ensures that a sufficient amount of heat 206 from the heat source 204 reaches and cooks the food 208 positioned on the grill 202. Stated differently, the smoke-generating device 100 is specifically designed to not overly obstruct or otherwise interfere with the cooking process.

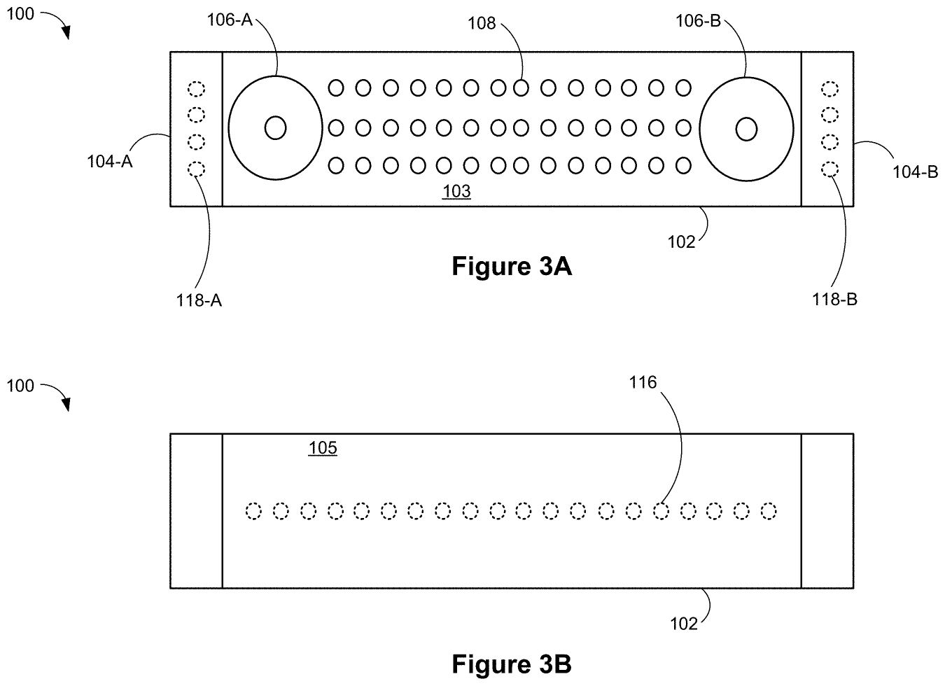

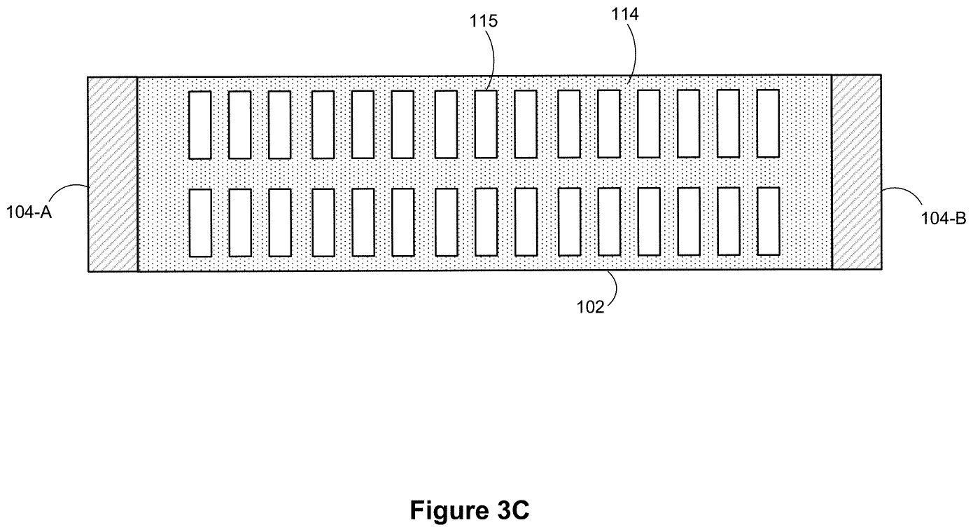

FIGS. 3A and 3B show top and bottom views, respectively, of the example smoke-generating device 100 of FIGS. 1A and 1B in accordance with some embodiments. It should be noted that the sizes of the first and second end caps 104 in FIGS. 3A through 3C are enlarged relative to FIGS. 1A through 2B. The first and second end caps 104 may be enlarged, at least in some embodiments, to accommodate additional holes 118 (optional), which are discussed in detail below.

As shown in FIG. 3A, the first magnet 106-A and the second magnet 106-B are positioned on the elongated housing 102 so as to not obstruct the plurality of holes 108. Stated differently, the first magnet 106-A is positioned toward a first end of the elongated housing 102 (e.g., the left end), the second magnet 106-B is positioned toward a second end of the elongated housing 102 (e.g., the right end), and the plurality of holes 108 are defined between the first and second ends of the elongated housing 102 (e.g., the holes 108 are defined along a body portion of the housing 102).

In some embodiments, the first end cap 104-A defines additional holes 118-A that are configured in the same manner of the plurality of holes 108. In other words, the additional holes 118-A are configured to direct smoke produced by the smoke-generating material 115 away from the first surface 103 of the elongated housing 102 toward a cooking surface. Likewise, in some embodiments, the second end cap 104-B defines additional holes 118-B that are configured in the same manner of the plurality of holes 108. The additional holes 118 may be included in the smoke-generating device 100 to further increase a smoke footprint of the smoke-generating device 100.

FIG. 3B shows a second surface 105 (i.e., a bottom surface 105) of the elongated housing 102. In some embodiments, the second surface 105 of the elongated housing 102 is a continuous surface, such that no holes or apertures are defined in the second surface 105. Alternatively, in some embodiments, the second surface 105 of the elongated housing 102 defines a plurality of heat-intake ports/holes 116 configured to distribute heat along and inside the elongated housing 102 (to ignite the smoke-generating material housed therein). In some embodiments, the plurality of heat-intake ports 116 are positioned at a lowest point on the elongated housing 102, such that the plurality of heat-intake ports 116 are positioned as close as possible to a heat source (e.g., heat source 204, FIG. 2B). Alternatively, the heat-intake ports 116 may be defined elsewhere on the second surface 105. In the illustrated embodiment, the plurality of heat-intake ports 116 are defined in a straight line along a longitudinal dimension of the elongated housing 102. In some other embodiments, the plurality of heat-intake ports 116 are defined in a zigzag pattern, or various other patterns. Furthermore, fewer or more heat-intake ports 116 may be defined in the second surface 105 of the elongated housing 102, relative to the number of heat-intake ports 116 shown in FIG. 3B. In some embodiments, the plurality of heat-intake ports 116 and the plurality of smoke-emitting ports 108 have the same configuration and are defined opposite each other in the housing 102 (e.g., their respective configurations mirror each other). In some other embodiments, the plurality of heat-intake ports 116 and the plurality of smoke-emitting ports 108 have different configurations (e.g., their respective configurations do not mirror each other). Note that in those embodiments where the smoke-generating material is a liquid, the elongated housing 102 does not include the plurality of heat-intake ports 116.

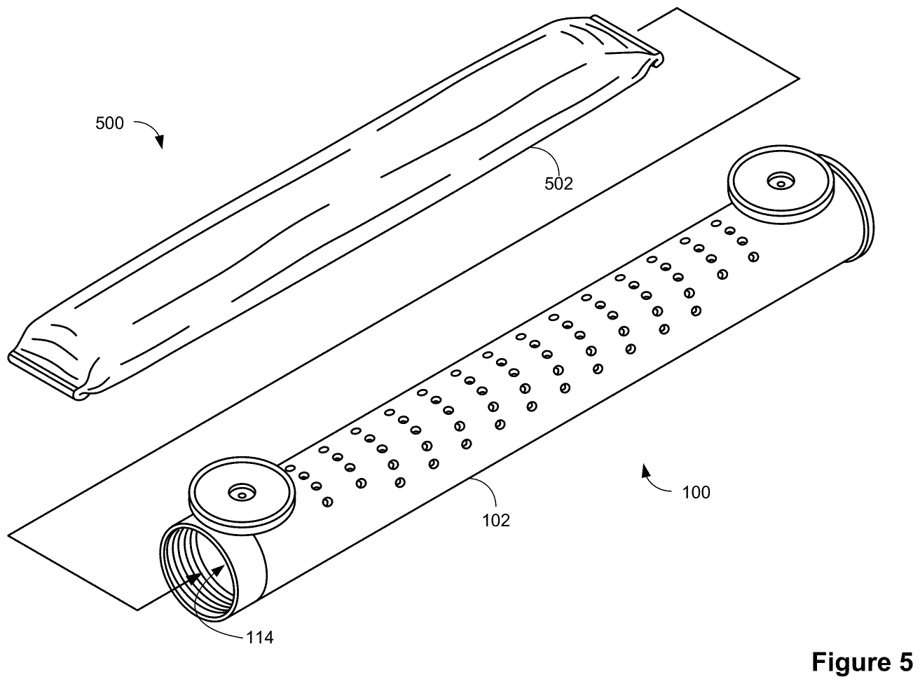

FIG. 3C shows a cross-sectional view (taken along line A-A¹ of FIG. 2B) of the example smoke-generating device 100 in accordance with some embodiments. As shown, a plurality of wood pellets 115 (or some other smoke-generating material) are positioned within the internal cavity 114 of the elongated housing 102. While not specifically shown in FIG. 3C, the plurality of wood pellets 115 may be housed (or were originally housed) in a fuel pod, such as the pod 500 shown in FIG. 5.

FIGS. 4A and 4B show additional components for the example smoke-generating device 100 in accordance with some embodiments. In particular, FIG. 4A shows an adapter/connector 400 that is used to connect (splice) two instances of the example smoke-generating device 100, as shown in FIG. 4C. Like the elongated housing 102, the adapter 400 may be made from a heat-resistant material, such as stainless steel, cast iron, etc. In some embodiments, the adapter 400 is made from the same material as the elongated housing 102, while in some other embodiments, the adapter 400 is made from a different material than the elongated housing 102. Like the end cap 104, the adapter 400 may include a first set of threads 402 that complement a corresponding set of threads of the smoke-generating device 100-A and a second set of threads 404 that complement a corresponding set of threads of the smoke-generating device 100-B. Additionally, the adapter 400 includes a non-threaded portion 406 between the first set of threads 402 and the second set of threads 404. A width of the non-threaded portion 406 can be varied (e.g., its width can be larger or smaller than the width shown in FIG. 4A). In some embodiments, the adapter 400 includes holes 408 that are configured in the same manner of the plurality of holes 108. In other words, the holes 408 are configured to direct smoke produced by the smoke-generating material 115 away from the first surface 103 of the elongated housing 102 toward a cooking surface.

As shown, the adapter 400 is configured to detachably couple to a respective end of each elongated housing 102-A and 102-B using threads. In some other embodiments, the adapter 400 is detachably coupled to the housings 102-A and 102-B by other means, such as magnets, a spring-locking mechanism, an external latching device, or some other mechanism. Note that the adapter 400 may have different shapes in other embodiments. For example, the adapter 400 may be T-shaped to allow three smoke-generating devices 100 to be coupled together at a single joint. In another example, the adapter 400 may be L-shaped, which would allow various smoke-generating devices chains to be created. Also, when multiple L-shaped adapters 400 are attached to four or more smoke-generating devices, a rectangle of smoke-generating devices can be formed. The key here is that many different shapes of smoke-generating devices can be made using the adapter 400 (or multiple adapters), which allows a cook to tailor a smoke pattern produced by the linked smoke-generating devices to a geometry of the food(s) being cooked.

In some embodiments, a first end of the elongated housing 102 is a male component (threaded on outside surface) and a second end of the elongated housing 102 is a female component (threaded on the inside surface). In this arrangement, a first respective elongated housing 102 can be connected to a second respective elongated housing 102 by connecting the male component of the first respective elongated housing 102 with the female component of the second respective elongated housing 102 (or vice versa). In such embodiments, the first end of the elongated housing 102 may have a smaller diameter than a diameter of the second end of the elongated housing 102.

FIG. 4B shows a top view of an example end cap 104. End caps 104 are described in further detail above, and, for the sake of brevity, any duplicate description is not repeated here.

FIG. 5 shows a fuel pod 500 (sometimes called a “pod” herein) that is sized to fit inside the smoke-generating device 100 in accordance with some embodiments. Stated differently, a shape of the pod 500 substantially complements a shape of the internal cavity 114 of the elongated housing 102. At bottom, the pod 500 is designed to ignite and distribute heat to the smoke-generating material therein, as discussed below. In this way, the smoke-generating material is able to generate smoke in a uniform fashion, which results in a better cooking experience. Specifically, the pod 500 includes (i) a smoke-generating material (e.g., material 115, FIG. 2B) configured to smoke when heated (as described with reference to FIG. 2B) and (ii) a sleeve 502 that surrounds the smoke-generating material. The sleeve 502 is also configured to ignite when heated to or above a predefined temperature, and, in turn, ignite the smoke-generating material.

In some embodiments, the sleeve 502 is a paper wrapping that contains the smoke-generating material. In some instances, the sleeve 502 is used to accelerate ignition of the smoke-generating material. In such instances, the sleeve 502 may include an accelerant coating or liner. In some other instances, however, the sleeve 502 is used to hinder ignition of the smoke-generating material. Stated differently, the sleeve 502 is used to prolong the smoke life of the smoke-generating material. In this way, the smoke-generating material does not have to be soaked in water before use. Note that the sleeve 502 may serve each of the purposes discussed above. For example, the sleeve 502 may be used to trigger ignition of the smoke-generating material and uniformly heat the smoke-generating material, while also prolonging the smoke life of the smoke-generating material. To accomplish this, the sleeve 502 may include multiple layers, where a first layer is combustible at a low temperature, while a second layer is heat resistant, such that the second layer slowly chars as opposed to combusting.

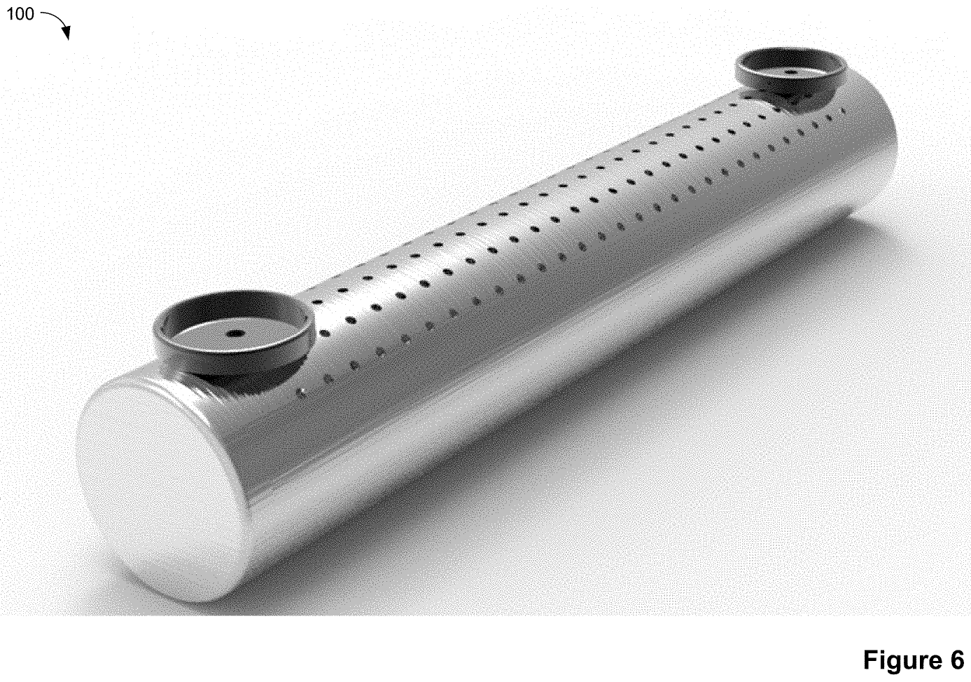

FIG. 6 shows a computer rendering of the smoke-generating device 100 in accordance with some embodiments. The computer rendering highlights the slender and sleek design of the smoke-generating device 100. Furthermore, the computer rendering also shows an embodiment of the smoke-generating device 100 with a closed end (as opposed to the open end shown in FIG. 1B). Note that a diameter of the holes 108 are small in some embodiments (such as in FIG. 6) and slightly larger in some other embodiments (such as in FIG. 1A). Moreover, in some embodiments, some holes in the plurality of holes 108 may have a first diameter, while some other holes in the plurality of holes 108 may have a second diameter different from the first diameter.

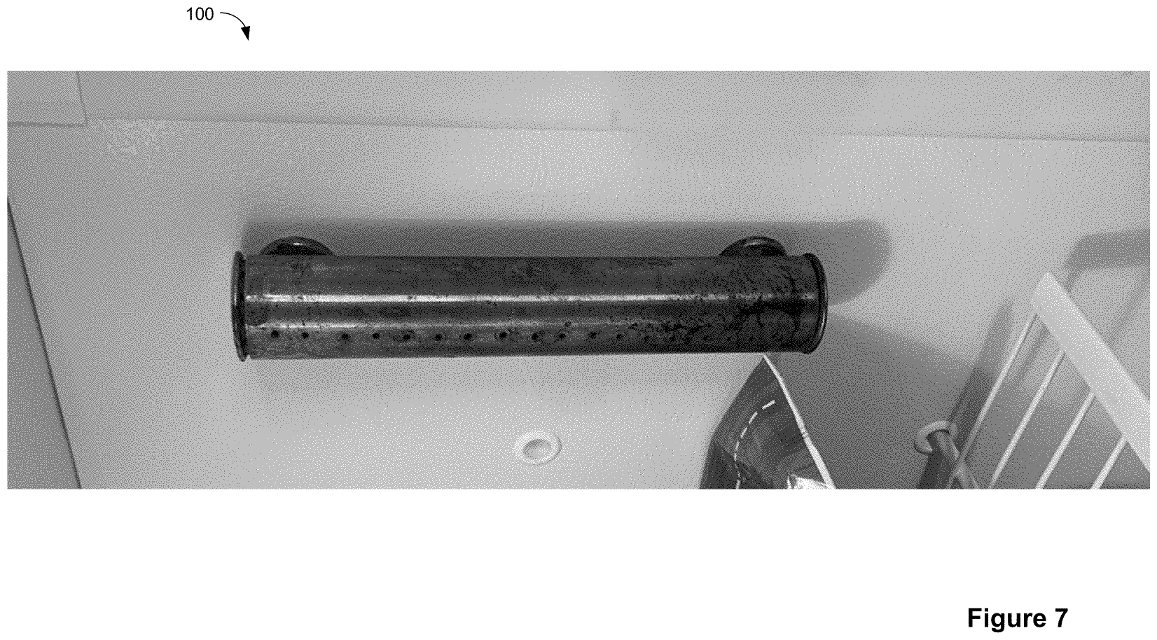

FIG. 7 shows an alternative use for the device 100. In particular, the device 100 may be used for purposes other than generating smoke. For example, an odor-eliminating material (e.g., baking soda, air freshener, etc.) may be housed in the device 100, and the odor-eliminating material may permeate out of the holes 108 (and potentially holes 116) into a space, such as a refrigerator, freezer, room, cabin of a vehicle, etc. As one illustrative example, some heavy machinery have an enclosed cabin with exposed ferrous metal structures therein, such as a support pillar. In such instances, the device 100 may be magnetically coupled to the metal structure and diffuse odor-eliminating material into the vehicle's cabin.

In some embodiments, the sleeve 502 may be a permeable material that houses the odor-eliminating material. In such embodiments, the sleeve 502 may be configured to release the odor-eliminating material from the housing 102 at a desired rate and intensity.

FIG. 8 is an oblique view of another example smoke-generating device 100 for generating cooking smoke in accordance with some embodiments. The smoke-generating device 100 includes means for collecting food grease (and other food runoff) so that the food grease does not clog the smoke-emitting ports 108 or enter the internal cavity 114 via the smoke-emitting ports 108. As shown, the smoke-emitting ports 108 are split into a first set of holes 108-A and a second set of holes 108-B, and the elongated housing 102 defines a well 802 (e.g., a trench, channel, etc.) that separates the first and second sets of holes 108-A, 108-B. In this arrangement, during use (e.g., when meat is being cooked directly above the smoke-generating device 100, as shown in FIG. 2B), a majority of the grease and other runoff from the food being cooked collects in the well 802. Grease not collected by the well 802 that drops from the cook and strikes the elongated housing 102 tends to slide off the elongated housing 102 due to its curved shape, as opposed to collecting in the smoke-emitting ports 108.

In some embodiments, the well 802 is most shallow towards the middle of the elongated housing 102, and most deep towards the ends of the elongated housing 102. Stated another way, the well 802 deepens as you move away from the center of the elongated housing 102. In such embodiments, the well 802 is able to self-drain at its ends (indicated by circle 804). As such, the well 802 can be designed so that it does not overflow, which further helps to prevent the smoke-emitting ports 108 from becoming clogged.

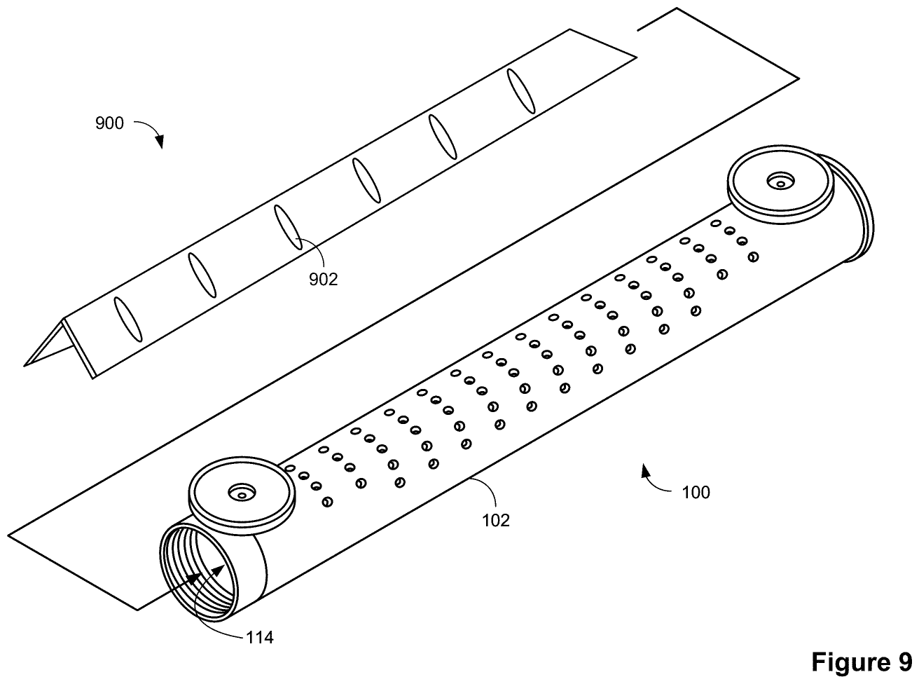

FIG. 9 shows a grease shield 900 that is sized to fit into the example smoke-generating device 100 of FIGS. 1A and 1B in accordance with some embodiments. The grease shield 900 is made from a heat-resistant material and is configured to slide inside the elongated housing 102 to protect the smoking-generating material 115 from food grease and other food runoff. Moreover, the grease shield 900 includes smoke-relief ports 902 that allow smoke produced by the smoking-generating material 115 to freely exit the elongated housing 102 via the smoke-emitting ports 108. Note that the grease shield 900 can alternatively be placed outside the elongated housing 102 and be used to shield the smoke-emitting ports 108.

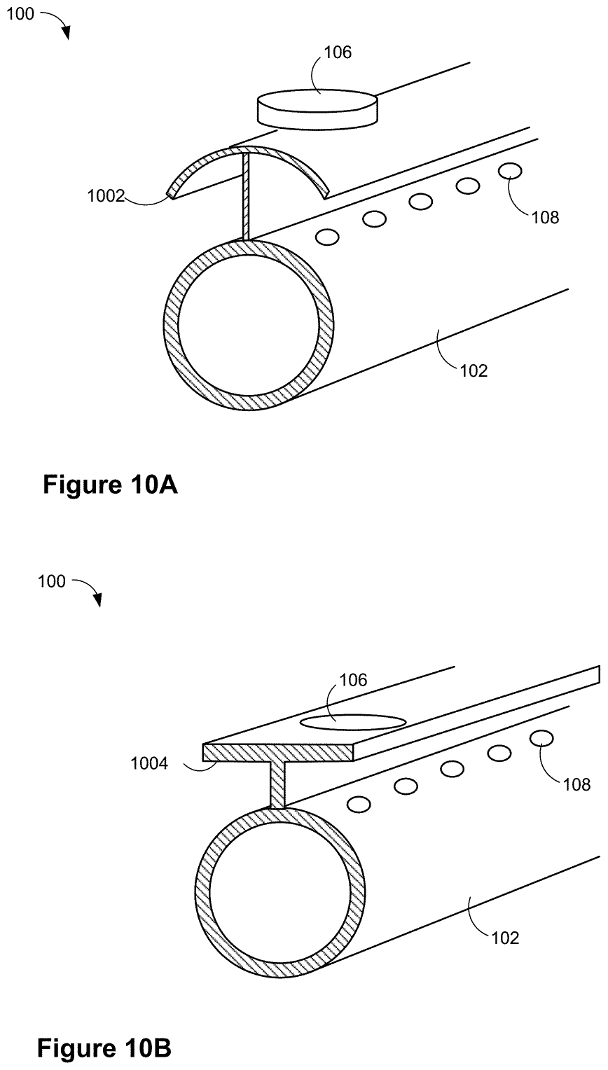

FIGS. 10A and 10B show additional grease shields that fit with the example smoke-generating device 100 of FIGS. 1A and 1B in accordance with some embodiments. In FIG. 10A, the grease shield 1002 has a curved shape and is configured to shield the smoke-emitting ports 108 from food grease. In such embodiments, the magnet(s) 106 can be attached to the grease shield 1002, as opposed to the elongated housing 102. In FIG. 10B, the grease shield 1004 is T-shaped and is configured to shield the smoke-emitting ports 108 from food grease. Due to its flat surfaces, the magnet(s) 106 can be coupled to or embedded in the grease shield 1004.

FIGS. 11A and 11B show alterative configuration for the elongated housing 102, the smoke-emitting ports 108, and the heat-intake ports 116. As shown in FIG. 11A, the elongated housing 102 is an octagon, whereby one set of smoke-emitting ports 108 is defined in a planar top surface of the octagon, such that the smoke-emitting ports 108 parallel the grill 202. Furthermore, three separate sets of heat-intake ports 116 are defined in the three lower surfaces of the octagon. In contrast, the elongated housing 102 in FIG. 11B includes two sets of smoke-emitting ports 108 that are not parallel to the grill 202 (the heat-intake ports 116 are somewhat similar to 11A).

Note that the elongated housing discussed herein is designed, at least in some embodiments, to limit an amount of oxygen that enters the internal cavity of the housing. Doing so reduces the risk of the smoke-generating material becoming aflame (i.e., burning too rapidly). This oxygen-limiting configuration allows the device 100 to maintain a safe, efficient, and consistent method of imparting smoke flavors to intended food items. Further, because a fuel pod can be quickly positioned inside the device 100, the device 100 is very easy to clean and reload with smoke-generating material. It should also be noted that the device 100 can also be placed in or one other cooking means, such in cooking pans.

The device 100 is dishwasher friendly and can be easily cleaned with a cylindrical type brush. Also, the device 100 is made from corrosion resistance materials such that the device 100 can be stored outdoors or indoors. Moreover, due to its elongated shape and magnetic-coupling mechanism (e.g., magnets 108), the device 100 can act as an auxiliary handle for an outdoor grill, or other metallic items (e.g., pots and pans positioned on an outdoor grill).

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An apparatus for producing culinary smoke, the apparatus comprising:
an elongated housing defining a first plurality of holes and an internal cavity accessible by an opening at an end of the elongated housing;
a magnetic-coupling mechanism coupled to the elongated housing and configured to detachably couple the elongated housing to an underside of a cooking grill; and
an end cap detachably coupled to the end of the elongated housing and configured to close the opening of the elongated housing,
wherein:
the internal cavity is configured to house a smoke-generating material that produces smoke when heated; and
the first plurality of holes is configured to direct the smoke produced by the smoke-generating material toward the cooking grill.

2. The apparatus of claim 1, wherein:
the elongated housing further defines a second plurality of holes on a substantially opposite portion of the elongated housing from the first plurality of holes; and
the second plurality of holes is configured to distribute heat inside the internal cavity to ignite the smoke-generating material housed therein.

3. The apparatus of claim 2, wherein the first plurality of holes and the second plurality of holes extend along a longitudinal length of the elongated housing.

4. The apparatus of claim 1, wherein the magnetic-coupling mechanism comprises:
a first magnet coupled to the elongated housing near the end of the elongated housing; and
a second magnet coupled to the elongated housing near an opposing end of the elongated housing.

5. The apparatus of claim 4, wherein:
the elongated housing includes a body portion between the end and opposing end; and
the first plurality of holes is defined on the body portion of the elongated housing.

6. The apparatus of claim 1, wherein:
the end of the elongated housing is a first end, and the elongated housing comprises a second end that is opposite the first end; and
the apparatus further comprises:
an additional elongated housing; and
an adapter connecting the second end of the elongated housing to an end of the additional elongated housing.

7. The apparatus of claim 6, wherein the adapter comprises:
a first connector configured to secure the adapter to the second end of the elongated housing; and
a second connector configured to secure the adapter to the end of the additional elongated housing.

8. The apparatus of claim 1, wherein:
the end of the elongated housing is a first end, and the elongated housing comprises a second end, opposite the first end, that defines another opening; and
the apparatus further comprises an additional end cap, detachably coupled to the second end of the elongated housing, that is configured to close the other opening of the elongated housing.

9. The apparatus of claim 1, wherein the smoke-generating material is a material selected from the group consisting of: wood chips, wood pellets, aromatic herbs, aromatic spices, a liquid, and a combination of the aforementioned.

10. The apparatus of claim 1, wherein:
the end cap comprises a threaded portion and an annular portion; and
the annular portion defines one or more holes that are configured to direct the smoke produced by the smoke-generating material toward the cooking grill.

11. The apparatus of claim 1, wherein each hole of the first plurality of holes has a diameter equal to or less than a threshold diameter to inhibit food residue from entering the elongated housing via the first plurality of holes.

12. The apparatus of claim 1, wherein:
the first plurality of holes includes a first set of holes and a second set of holes; and
the elongated housing further defines a grease well that separates the first set of holes from the second set of holes, the grease well being configured to catch food grease when the elongated housing is coupled to the underside of the cooking grill.

13. The apparatus of claim 1, further comprising a grease shield coupled to the elongated housing and configured to shield the elongated housing, at least partially, from food grease when the elongated housing is coupled to the underside of the cooking grill.

14. A system for generating culinary smoke, comprising:
a smoke-emitting apparatus, comprising:
an elongated housing defining a first plurality of holes and an internal cavity accessible by an opening at an end of the elongated housing; and
a magnetic-coupling mechanism coupled to the elongated housing and configured to detachably couple the elongated housing to an underside of a cooking grill, and
a fuel pod comprising: (i) smoke-generating material configured to produce smoke when heated and (ii) a sleeve that surrounds the smoke-generating material, wherein a shape of the pod complements a shape of the internal cavity of the elongated housing,
wherein:
the internal cavity is configured to receive and house the pod, and
the first plurality of holes is configured to direct smoke produced by the smoke-generating material toward the cooking grill.

15. The system of claim 14, wherein:
the sleeve is configured to ignite when heated to or above a predefined temperature; and
ignition of the sleeve causes the smoke-generating material to subsequently ignite.

16. The system of claim 15, wherein the sleeve is configured to, once ignited, distribute heat to the smoke-generating material therein.

17. The system of claim 14, wherein:
the elongated housing further defines a second plurality of holes; and
the second plurality of holes is configured to distribute heat along a longest dimension of the pod to uniformly ignite the sleeve.

18. The system of claim 14, wherein the smoke-generating material is a material selected from the group consisting of: wood chips, wood pellets, aromatic herbs, aromatic spices, a liquid, and a combination of the aforementioned.

19. An apparatus for producing culinary smoke, the apparatus comprising:
a cylindrical shell with an internal cavity accessible by an opening at an end of the cylindrical shell, the cylindrical shell defining a plurality of smoke-emitting ports;
one or more magnets, coupled to the cylindrical shell, configured to detachably couple the cylindrical shell to an underside of a cooking grill; and
an end cap, detachably coupled to the end of the cylindrical shell, that is configured to close the opening of the cylindrical shell,
wherein:
the internal cavity is configured to house a smoke-generating material that produces smoke when heated; and
the plurality of smoke-emitting ports is configured to direct the smoke produced by the smoke-generating material toward the cooking grill.

20. The apparatus of claim 19, wherein:
the cylindrical shell also defines a plurality of heat-intake ports on an opposite side of the cylindrical shell from the plurality of smoke-emitting ports; and
the plurality of heat-intake ports is configured to distribute heat inside the internal cavity to ignite the smoke-generating material housed therein.
